(19) United States
(12) Patent Application Publication
(10) Pub. No.: US 2013/0224356 A1
(43) Pub. Date: Aug. 29, 2013

(54) METHOD FOR MAKING MULTIPLE FROSTING FLOWERS

(71) Applicant: Kevin P. Determan, Sartell, MN (US)

(72) Inventor: Kevin P. Determan, Sartell, MN (US)

(21) Appl. No.: 13/779,708

(22) Filed: Feb. 27, 2013

Related U.S. Application Data
(60) Provisional application No. 61/604,052, filed on Feb. 28, 2012.

(51) Int. Cl. A23G 3/34

(52) U.S. Cl. CPC A23G 3/0019
USPC 426/512

(57) ABSTRACT

A method is described which increases the efficiency of making frosting flowers through the means of utilizing multiple flower nails simultaneously held by hand thereby increasing the rate of their production.

### RELATED APPLICATIONS

This application claims priority to U.S. Provisional Application No. 61/604,052 filed Feb. 28, 2012 which is hereby incorporated by reference in its entirety.

### BACKGROUND OF THE INVENTION

1. Field of the Invention

The present invention relates generally to the making of frosting flowers and more particularly to the method of making multiple frosting flowers.

2. Description of Related Art

The purpose of this invention is for a method of making multiple frosting flowers. Icing, also called frosting in the United States, is a sweet often creamy glaze made of sugar with a liquid, such as water or milk, that is often enriched with ingredients such as butter, egg whites, cream cheese, or flavorings. It is used to cover or decorate baked goods, such as cakes or cookies. Frosting flower is a universal term and is not limited to creating only decorative flowers.

Icing can be formed into shapes such as flowers and leaves using a pastry bag. Such decorations are common place on birthday and wedding cakes. Chef's color dye (food coloring) is commonly added to icing mixtures to achieve the desired color. Sprinkles, coloring mist, edible ink designs, or other decorations are often used on top of icing.

During the common method of constructing frosting flowers, as often described in industry magazines and on-line demonstrations made by subject matter experts in the field of decorative frosting, often a cone- or triangular-shaped, hand-held pastry bag made from cloth, paper, or plastic is used to pipe semi-solid foods by pressing them through a narrow opening at one end, for many purposes including cake decoration. The pastry bag is filled through a wider opening at the opposite end, rolled or twisted closed, and then squeezed to extrude its contents. For the purposes of making frosting flowers, as the pastry bag is squeezed, the contents flow out on to a single flower nail, or sometimes referred to a rose nail, which is then spun by hand in a way to obtain the desired flower pattern. The flower nail can either be bare, or covered with a piece of parchment paper. A flower nail, in the cake decorating industry typically consists of a two inch diameter flat disk that is supported in the middle by an attached sharp pointed nail like shaft with the intended use of being spun by a rolling action of the thumb, forefinger and middle fingers. Upon completion of the desired decorative flower, the pastry bag is set down and the decorative flower is lifted off the nail, typically done by using a pair of kitchen shears or equivalent. To construct the next flower, the process is repeated.

Alternatively, another common method of constucting flowers is to forgo the use of a flower nail and form the flower onto a piece of parchment paper. In this method, as one flower petal is formed, the process stops while the free hand (the one not holding the pastry bag) rotates the parchment paper in the orientation for proper creation of the next petal. This process is repeated until the flower is suitably formed to the liking of the operator. As with the use of the flower nail, the flower is removed from the parchment paper by using a pair of kitchen shears or equivalent.

### SUMMARY OF THE INVENTION

As a means to increase the rate of flowers one can produce, the present invention is a novel method for reducing the number of steps in the production process. Specifically, today's need to remove the flower from the nail each time one is completed has, with the present invention, been extended to only occur after the completion of multiple flowers.

As such, the method to increase the production rate, a multi-headed flower nail device is set on top of the user's hand and is controlled by the fingers that grasp a shaft connected directly and indirectly to three flower nails making the disks spin simultaneously allowing for frosting flowers to be made more quickly. Though shown in FIGS. 1-3, the present invention is not limited to 3 simultaneously spinning disks but to that of how many one can, as a practical means, hold in a typical adult sized hand. Smaller flowers require smaller disks and hence more could simultaneously be spun. The flower nails spin together via a connective band or via a connective gearing mechanism.

In addition to the present invention being a labor and time saver, due to the construction of the multiple flower nail configuration, it is an eye catcher for businesses that are making bakery items in a customer setting due the connective band between the adjoining flower nails having an opportunity for printed advertising printed on them.

The present invention incorporates three traditional flower nails that are modified for the purpose of making more frosting flowers in less time that a single flower nail. Of the three spinning flower nails, the one that is spun by the user is considered the drive flower nail. Its shaft is safer for the user as the sharp point in the present invention has been made into a blunt surface so as to be smooth and thereby reducing injury that can occur with pointed shafts of flower nails in use today.

In order to make a frosting flower on a typical flower nail in use today, the user:
A) Picks up the single flower nail in one hand
B) Picks up the pastry bag in the other hand
C) Spins the flower nail to make the frosting flower while squeezing out the pastry bag contents onto the flower nail
D) Sets the pastry bag down
E) Picks up a scissors or other device to take the frosting flower off the flower nail
F) Sets the finish frosting flower on the cake or other item being decorated.

To make three frosting flowers, the scissors and pastry bag have to be picked up and set down a total of six times (bag and scissors together). In addition, the pastry bag's frosting flower tip has to be re-oriented almost every time to make the frosting flower instead of conveniently holding it in one position the first time.

The present invention increases the efficiency of making frosting flowers through the method of:
A) Picking up the multi-headed flower nail device in one hand
B) Pick up the pastry bag in the other hand
C) Spin the shaft of the drive flower nail while squeezing out the pastry bag contents onto the multiple flower nails.
D) Set the pastry bag down.
E) Pick up a scissors or other device to take the frosting flowers off the flower nails
F) Set the finish frosting flowers on the cake or other item being decorated

During the method of making multiple frosting flowers the flower nails are simultaneously spun clockwise and counter-clockwise as part of the process. The frosting flowers are created in conjunction with the squeezing of a pastry bag that contains icing onto the disks through a tube at the bag's narrow end. The spinning motion is done by, but not limited to, the thumb, index, and middle fingers of either the right hand or left hand of the user. The user grasps onto the drive flower nail shaft which controls, in addition to the hand shaft, the motion of the other flower nails.

As such, the method of the present invention to increase the production efficiency is achieved through a novel housing that accommodates multiple flower nails. The housing, a bent rectangular rod similar in the shape of an elongated Z, contains a drilled out through hole on one end for a drive flower nail donut bearing and is sized so as to allow the donut bearing to be press fit in. The remaining donut bearings are press fit into recesses machined in the rod at its middle and opposite end of the drive nail flower. The bearings are sized such there is a friction fit between their inner diameter and shafts of the flower nails. It is through the manually driven rotation of the drive flower nail that, with the aid of the connective band snugly fit between all flower nail shafts, and with the non-drive flower nails secured into the donut bearings, the flower nails of the multi-headed flower nail assembly rotate in unison. To ensure engagement of the connective band to the shaft of the flower nails, the diameter of a section of the shaft is widened (wide disks) and has a groove machined into it to accommodate the width of the connective band. The band then rides within the groove which keeps it from traveling up and down the length of the shaft while in motion.

The rectangular rod is ergonomically shaped such that one section of the rod rests on the user's hand whereas the front section rises up at an angle so as to allow the thumb and fingers to conveniently grasp the shaft of the drive flower nail. An anti-slip pad is attached underneath the rectangular rod and rests on top of the hand to prevent unwanted movements.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

The attached drawings are included to provide additional understanding of the invention and are to be considered part of this description that illustrates the embodiments of the invention, and together with the detailed description provide an explanation of the principles of the invention.

Wherein the drawings:

FIG. 1 is an exploded perspective view of the present invention, showing an assembled device used in the method for making multiple frosting flowers utilizing a connective band to rotate the flower nails in unison.

FIG. 2 is an exploded perspective view of the present invention, showing an assembled device used in the method for making multiple frosting flowers utilizing a connective gearing mechanism to rotate the flower nails in unison.

FIG. 3 is an exploded perspective view of the present invention, showing an assembled device used in the method for making multiple frosting flowers utilizing multiple connective bands to rotate the flower nails in unison.

### DETAILED DESCRIPTION OF THE DRAWINGS

The present invention is referred to generally in FIGS. 1, 2 and 3 by the reference numeral 8 and is intended to provide for an illustration for the method for the making of multiple frosting flowers. Like numbers refer to like elements throughout the figures. It should be understood that the device 8 may be used in a variety of methods for making multiple frosting flowers.

Referencing FIG. 1, the main structure of the multiple frosting flower maker is the housing 14 preferably but not limited to being made of food grade poly material for reduced weight, as would be the wide disks 18. The structure of the housing 14 is shaped as a rectangular rod in such a way that would be the most ergonomic for the user, based upon the wants and needs of its manufacturer, but would be contained within the dimensions necessary for use by sitting on top of the user's hand. It can also be used right or left handed. Donut bearings 16 are inset into the housing 14, a total of three spaced evenly within the housing 14, designed to receive shafts 28, 30 and drive flower nail shaft 24. The wide disks 18 would be situated on the drive flower nail shaft 24, and shafts 28, and 30 in such a way as to accommodate the latex free stretchable band 12 to unify all spinning components. The stretchable band 12 could also include printing(s) for various uses such as advertising. The structure of the flat disks 10 are usually round in shape. Their sizes are such to provide a reasonably sized surface to make a typical size frosting flower of approximately 1 inch in diameter. The disks are made with, but not limited to, a lightweight food grade tin or other suitable material. The donut bearings 16 contain food grade lubricant inside the bearing itself, and are water proof for easy clean-up. The anti-slip pad 22 is made of any non-slip food grade material. All components could be made of a multitude of suitable materials for constructing the multiple frosting flower system.

Shafts 28 and 30 are comparable in diameter to a nine penny nail and both are set in donut bearings 16 shown with dotted lines. The shafts also go through and are secured to the wide disks 18—one on each shaft 28, 30 also shown with dotted lines. Drive flower nail shaft 24 is comparable in diameter to a nine penny nail, its outer surface being textured for added gripping ability while it is held and spun with the user's fingers. The drive flower nail shaft 24 goes through one wide disk 18 shown with dotted lines and is set in donut bearing 16 shown with dotted lines. Latex free flat disks 10 are usually round in shape, they set atop all shafts 24, 28, and 30 where frosting flowers are made normally with a pastry bag squirting icing through a tube on the bag's end onto the disks 10.

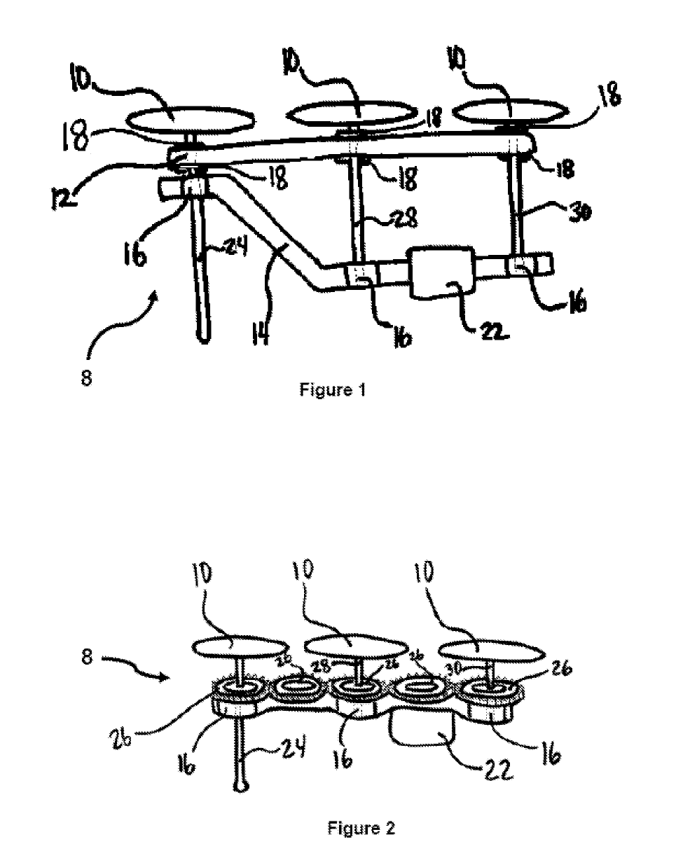

FIG. 2 shows the shape of housing 14 in FIG. 1 is replaced with a flat style design as shown and replace the stretchable band 12 with a gear system 26 that would unify all components necessary to spin clockwise and counter-clockwise to make frosting flowers.

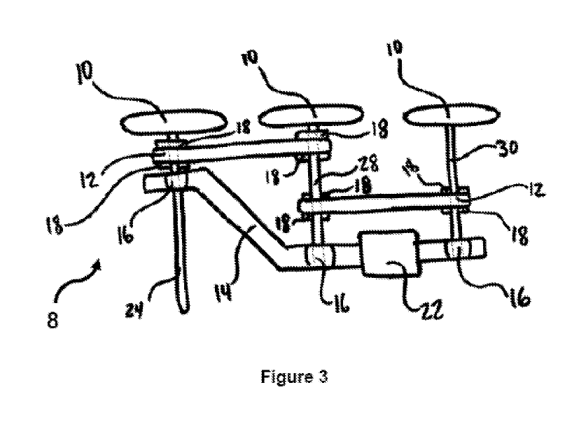

FIG. 3 shows two stretchable bands 12 instead of one stretchable band 12 as in FIG. 1. A second wide disk 18 is added to the bottom of shaft 28 to accommodate the extra band. Wide disk 18 is positioned further down on shaft 30 to align with the lowered wide disk 18 on shaft 28.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

I claim:

1. A method for making multiple frosting flowers that includes a multi-headed flower nail assembly consisting of:
a drive flower nail and passive flower nails, wherein said both flower nail types consist of a disk with a first and second surface, and a cylindrical shaft with first and second ends with said first shaft end centrally attached to said flower nail disk first surface;
a rectangular rod with a first and second surface, first and second ends, a midpoint evenly spaced between said first and second ends, where said shaft of said drive flower nail protrudes through an opening of said first and second rectangular rod surfaces where said opening houses a donut bearing located within said rectangular rod at said first end, and said cylindrical shaft second ends of said passive flower nails protrude into a recessed opening of said first rectangular rod surface at said rectangular rod second end and said midpoint where said recessed openings house a donut bearing;
a mechanical attachment means between said flower nails consisting of a stretchable band fitting over said flower nail shafts allowing for said flower nails to rotate in unison when said shaft of said drive flower nail is actuated to spin;
wherein the multiple frosting flowers are created comprising the steps of:
holding the multi-headed flower nail assembly in one hand;
placing said shaft of said drive flower nail between the thumb, forefinger and middle finger of said hand holding the multi-headed flower nail assembly;
spinning said shaft of said drive flower nail by said thumb, forefinger and middle finger;
squeezing out frosting from a pastry bag with the other hand onto said second disk surface of one of the heads of the multi-headed flower nail assembly to form a frosting flower;
forming subsequent frosting flowers on remaining flower nails from said multi-headed flower nail assembly by spinning said shaft of said drive flower nail by said thumb, forefinger and middle finger and squeezing out frosting from said pastry bag by said other hand;
setting down said held pastry bag thereby freeing said hand; and
removing said frosting flowers from said flower nails with a removal device using said free hand.

2. The method of claim 1 wherein the multi-headed flower nail assembly consists of three flower nails.

3. The method of claim 1 wherein said second end of said shaft of said drive flower nail consists of smooth blunt nose surface to reduce injury to said hand during said spinning step.

4. The method of claim 1 wherein the step using said removal device is a scissors.

5. The method of claim 1 wherein the step of holding the multi-headed flower nail assembly may utilize either hand.

6. The method of claim 1 wherein the flower nail disk diameter of said multi-headed flower nail assembly determines the overall diameter of said frosting flower.

7. The method of claim 6 wherein the disks of said flower nails may each be of a different diameter.

8. The method of claim 1 wherein said forming steps include forming frosting flowers on one or more of the available frosting nails on said multi-headed flower nail assembly.

9. The method of claim 1 wherein the steps eliminate the necessity of setting down said held pastry bag and said frosting flower removal between subsequent frosting flower creations.

10. The method of claim 9 wherein the step increases the production rate of said frosting flowers.

11. The method of claim 1 wherein said rectangular rod consists of an anti-slip pad attached to said second surface located between said rectangular rod second end and said midpoint to minimize rotation of said rectangular rod during said spinning steps.

12. The method of claim 1 wherein the surface of said shaft of said drive flower nail is textured to allow for increased grip between said thumb, forefinger and middle finger during said spinning step.

13. The method of claim 1 wherein the shape of said rectangular rod is bent in an elongated Z for ergonomic hand comfort during the method of producing multiple frosting flowers.
